(19) United States
(12) Patent Application Publication
(10) Pub. No.: US 2026/0169988 A1
(43) Pub. Date: Jun. 18, 2026

(54) VIRTUAL JOIN INDEX FOR COST-BASED LATE MATERIALIZATION

(71) Applicant: Teradata US, Inc, San Diego, CA (US)

(72) Inventor: Ming Zhang, Rolling Hills Estates, CA (US)

(73) Assignee: Teradata US, Inc, San Diego, CA (US)

(21) Appl. No.: 18/983,597

(22) Filed: Dec. 17, 2024

(51) Int. Cl. G06F 16/2453

(52) U.S. Cl. CPC G06F 16/24545; G06F 16/24544

(57) ABSTRACT

A method, apparatus, and computer program product for executing a relational database management system (RDBMS) in a computer system, wherein the RDBMS manages a relational database comprised of one or more tables storing data. A virtual join index provides a new query optimization method based on enhanced join-index-rewrite to achieve cost-based late-materialization benefits without the costs for join index creation, storage and maintenance. The virtual join index is not materialized, but instead is treated by an optimizer as join index with dynamically determined columns to rewrite the query. In the join index rewrite, the columns of the virtual join index are dynamically determined by join columns in the query to produce a partial-covering query execution plan. Then, in the query execution plan, the virtual join index is replaced by a base table to produce the late materialization query execution plan.

### BACKGROUND OF THE INVENTION

### 1. Field of the Invention

This invention relates to query optimization in computer-implemented relational database management systems.

### 2. Description of Related Art

Computer systems implementing a relational database management system (RDBMS) are well known in the art. An RDBMS stores data as tables (also referred to as relations) comprised of rows and columns (also referred to as tuples and attributes, respectively), and uses a data manipulation language (DML), such as a structured query language (SQL), to create, update and access the data via user queries.

The SQL interface allows users to formulate relational operations on the tables. One of the most common SQL queries executed by the RDBMS is the SELECT statement. In the SQL standard, the SELECT statement generally comprises the format: “SELECT <clause> AS <clause> FROM <clause> WHERE <clause>.” The clauses generally must follow this sequence, but only the SELECT and FROM clauses are required.

Generally, the result of a SELECT statement is a subset of data retrieved by the RDBMS from one or more existing tables stored in the relational database, wherein the FROM clause identifies the name of the table or tables from which data is being selected. The subset of data is treated as a new table, termed the result table.

A join operation is usually implied by naming more than one table in the FROM clause of a SELECT statement. A join operation makes it possible to combine tables by combining rows from one table with another table. The rows, or portions of rows, from the different tables are concatenated horizontally. Although not required, join operations normally include a WHERE clause that identifies the columns through which the rows can be combined. The WHERE clause may also include a predicate comprising one or more conditional operators that are used to select the rows to be joined.

Techniques have been developed for maximizing performance using join operations. However, there remains a need in the art for additional optimization techniques using join operations.

### SUMMARY OF THE INVENTION

The present invention discloses a method, apparatus, and computer program product for executing a relational database management system (RDBMS) in a computer system, wherein the RDBMS manages a relational database comprised of at least a first table and a second table storing data.

The RDBMS creates or accesses a virtual join index for processing columns of the first table and/or the second table, wherein the first table and/or second table is column partitioned. The RDBMS processes a query that performs a join operation of the first table with the second table. The RDBMS uses the virtual join index to produce and cost a late-materialization query execution plan for the query. The columns of the first table and/or second table are assembled into rows during materialization, before the rows are returned as results for the query.

The virtual join index is a non-sparse join index containing only row identifiers for the first table or the second table in a creation statement for the virtual join index, but the virtual join index does not materialize any columns from the first table or the second table. The virtual join index is replaced by the first table or the second table to produce and cost the late-materialization query execution plan. Specifically, the virtual join index is replaced with dynamically determined columns from the first table or the second table to produce and cost the late-materialization query execution plan for the query. The dynamically determined columns comprise columns referenced by the join operation in the query, and the dynamically determined columns are materialized before the RDBMS performs the join operation in the query.

The cost of the late-materialization query execution plan for the query is compared with a cost of an early-materialization query execution plan for the query, to select the late-materialization query execution plan or the early-materialization query execution plan for execution by the RDBMS.

### BRIEF DESCRIPTION OF DRAWINGS

Referring now to the drawings in which like reference numbers represent corresponding parts throughout:

FIG. 1 illustrates an exemplary hardware and software environment according to one embodiment of the present invention.

FIG. 2 further illustrates an exemplary set of functions performed by a parsing engine when coordinating the retrieval of data in response to a query.

FIG. 3 further illustrates an exemplary set of functions performed by a parser when interpreting a query.

FIG. 4 illustrates a query execution plan with early materialization.

FIG. 5 illustrates a query execution plan with late materialization.

FIG. 6 illustrates a partial join-index-covering query execution plan using join indexes.

FIG. 7 illustrates a partial join-index-covering query execution plan using virtual join indexes.

FIG. 8 illustrates a late-materialization query execution plan using virtual join indexes and base tables.

FIG. 9 is a flowchart that illustrates the steps performed in the present invention, when executing an RDBMS in a computer system, wherein the RDBMS manages a relational database comprised of one or more tables storing data.

### DETAILED DESCRIPTION OF THE INVENTION

In the following description of the preferred embodiment, reference is made to the accompanying drawings, which form a part hereof, and in which is shown by way of illustration a specific embodiment in which the invention may be practiced. It is to be understood that other embodiments may be utilized, and structural changes may be made without departing from the scope of the present invention.

### Overview

The present invention improves computer performance when performing joins in a relational database management system. Specifically, this invention introduces the concept of a virtual join index and proposes a new query optimization method based on enhanced join-index-rewrite guided by the virtual join index to achieve cost-based late-materialization benefits without the costs for join index creation, storage and maintenance.

In this invention, a virtual join index is not materialized, but instead is treated by the optimizer as join index with dynamically determined columns to rewrite the query. Specifically, in the join index rewrite, the columns of the virtual join index are dynamically determined by join columns in the query to produce a partial-covering query execution plan; then, in the query execution plan, the virtual join index is replaced by a base table to produce the late materialization query execution plan.

This approach has the following advantages:
The cost-based join index rewrite is used, which has the logic to compare the estimated cost of the late-materialization query execution plan with the original early-materialization query execution plan; it is a cost-based optimization by nature without need to implement the separate logic for the cost-based optimization.
The virtual join index does not materialize any column, and thus does not require data storage space and maintenance costs, as would be needed for a regular join index.
As the “virtual” columns of a virtual join index are dynamically determined during the process of the join index rewrite, one virtual join index on a table can be used for any queries defined on the table.

In summary, the approach of this invention integrates the late materialization with the cost-based join-index rewrite flow, and achieves performance benefits similar to a join-index partial-covering query execution plan without paying the cost for regular join index creation, storage and maintenance.

### Hardware and Software Environment

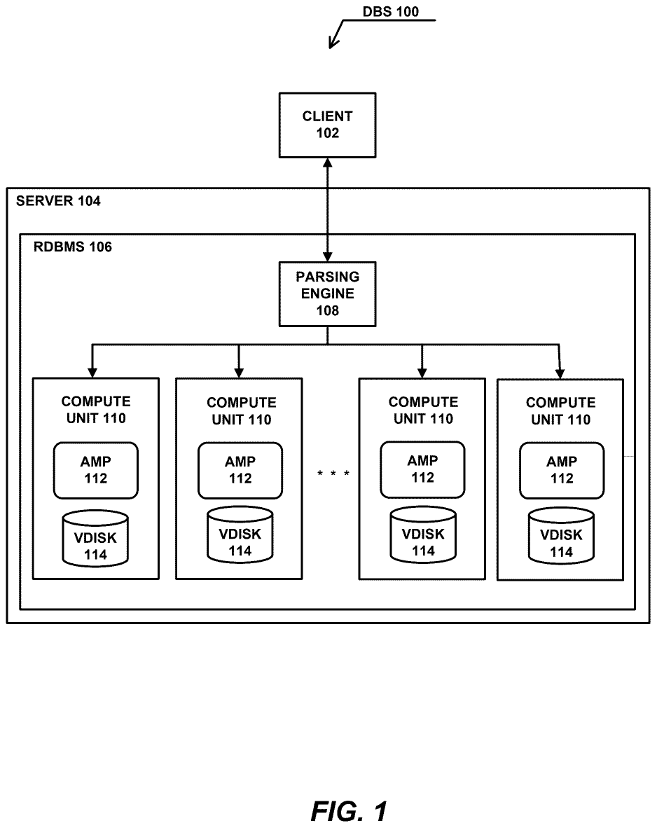

FIG. 1 illustrates an exemplary hardware and software environment according to one embodiment of the present invention. In the exemplary environment, a database system (DBS) 100 is a computer system that implements a client-server architecture, wherein one or more client computers 102 may include, inter alia, a graphical user interface (GUI), which allows one or more users to interface with one or more server computers 104, which implement an RDBMS 106 that manages a relational database comprised of one or more tables storing data. The DBS 100 may be implemented in separate machines, or may be implemented as separate or related processes in a single machine.

In one embodiment, the RDBMS 106 includes a parsing engine (PE) 108 that organizes storage of the data and coordinates retrieval of the data from the storage, one or more compute units 110 executing one or more access module processors (AMPs) 112 performing the functions of the RDBMS 106, and one or more virtual disks (VDISKs) 114 storing the relational database of the RDBMS 106. The compute units 110 comprise processors, and the AMPs 112 and VDISKs 114 comprise processes that may be implemented in one or more separate machines or in a single machine.

The RDBMS 106 used in one embodiment comprises the Teradata® Vantage® RDBMS sold by Teradata™ US, Inc., the assignee of the present invention, although other DBMS's could be used as well. In this regard, the Teradata® Vantage® RDBMS is a hardware and software based data warehouse, decision support system, and data analytics system.

Generally, users of the system 100 interact with the client computers 102 to formulate requests for the RDBMS 106 executed by the server computers 104, wherein the requests access data stored in the RDBMS 106, and responses are received therefrom. In response to the requests, the RDBMS 106 performs the functions described below, including processing data retrieved from the RDBMS 106. Moreover, the results from these functions may be provided directly to the client computers 102, or may be provided to other computer systems (not shown), or may be stored by the RDBMS 106 in the relational database.

Note that, in one or more embodiments, the system 100 may use any number of different parallelism mechanisms to take advantage of the parallelism offered by the multiple tier architecture, the client-server structure of the client computers 102, server computers 104, RDBMS 106, PE 108, and the multiple compute units 110, AMPs 112 and VDISKs 114 of the RDBMS 106. Further, data within the relational database may be partitioned across multiple data storage devices to provide additional parallelism.

Tables can be partitioned using column and/or row partitioning, wherein row partitioning horizontally partitions tables into groups of one or more rows, while column partitioning vertically partitions tables into groups of one or more columns. The column values of a column-partitioned table are stored in one or more containers spread across one or more data blocks, along with a row identifier (RowID). When a query filters the column values based upon a predicate, all the containers for the columns spread across the data blocks are read and one or more qualified column values are returned, along with their associated RowIDs. Thus, column-partitioned tables offer the advantage of electing only a subset of columns, thereby decreasing the costs associated with reading data.

Generally, the client computers 102, server computers 104, RDBMS 106, PE 108, compute units 110, AMPs 112 and VDISKs 114 comprise hardware, such as computers, processors, data storage devices and networks, and software, such as instructions, logic and/or data tangibly embodied in and/or accessible from a non-transitory device, media, or carrier, such as RAM, ROM, one or more of the data storage devices, and/or a remote system or device communicating with the DBS 100 via one or more of the networks, thereby making a computer program product or article of manufacture according to the invention. As such, the terms “article of manufacture,” “program storage device” and “computer program product” as used herein are intended to encompass program instructions accessible from any computer readable storage medium. Accordingly, such articles of manufacture are readable by a computer system and the program instructions are executable by the computer system to cause the computer system to perform various method steps of the invention.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

### Parsing Engine

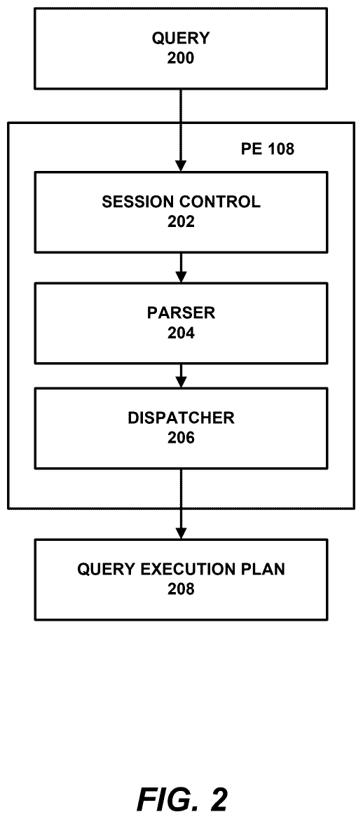

FIG. 2 further illustrates an exemplary set of functions performed by the PE 108 when coordinating the retrieval of data in response to a query 200. In one example, the PE 108 performs at least three functions: a session control 202, a parser 204, and a dispatcher 206. The session control 202 provides logon and logoff functions, and processes requests for access to the database. Once the session control 202 allows a request for access to the database to begin, the query 200 is routed to the parser 204, which interprets the query 200, and then to the dispatcher 206, which schedules and executes one or more resulting query execution plans 208 generated by the parser 204 using the AMPs 112 and VDISKs 114.

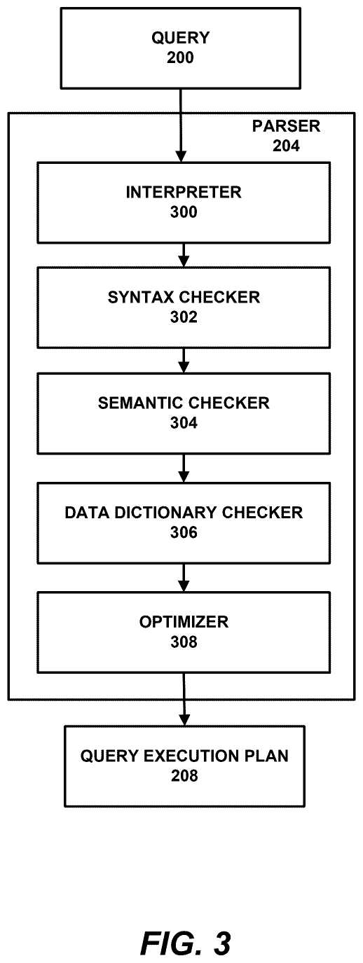

FIG. 3 further illustrates an exemplary set of functions performed by the parser 204 when interpreting the query 200. An interpreter 300 interprets the query 200, a syntax checker 302 checks the query 200 for proper syntax, a semantic checker 304 evaluates the query 200 semantically, and a data dictionary checker 306 consults a data dictionary to ensure that all the data objects specified in the query 200 actually exist and that the user has the authority to access the data objects. Finally, an optimizer 308 generates one or more query execution plans 208 for the query 200 and selects an optimal query execution plan 208 (e.g., the least expensive plan) for the query 200, which is subsequently performed by the RDBMS 106.

Late and Early Materialization during Query Processing

When the RDBMS 106 performs a query execution plan 208, late materialization (for example, on a column-partitioned table) defers materialization of columns from a base table until the columns are needed, thus reducing the size of intermediate results and bringing performance benefits in many cases. However, late materialization needs to access the base table more than once and does not always provide better performance than early materialization. Therefore, late materialization is expected to be a cost-based optimization. Most late materialization strategies found in the literature are rule-based, as described in [1] [2] [3] in the “References” section set forth below.

When the RDBMS 106 is processing column-partitioned tables, the data is stored by columns; however, at a certain point during processing, the RDBMS 106 needs to read the column values and assemble them into a row representation before returning the rows (as results of the query) to the user. This process of row construction is called materialization. Roughly, there are two materialization strategies: early materialization and late materialization:
Early materialization: when processing a query, if a column is needed by any operators or included in the output, then materialize the column value at the time of first accessing this row.
Late materialization: defer the materialization of columns to the time that they are needed (either by an operator or in the output).

Consider the following query 200 that illustrates the differences between early and late materialization:

```
SELECT *
FROM store_sales_cp, store_returns_cp
WHERE ss_sold_date_sk < sr_returned_date_sk-365
  AND ss_item_sk=sr_item_sk
  AND ss_customer_sk=sr_customer_sk;
```

In this query 200, the store_sales_cp table includes columns for ss_sold_date_sk (sold date surrogate key), ss_item_sk (item surrogate key), and ss_customer_sk (customer surrogate key), while the store_returns_cp table includes columns for sr_returned_date_sk (returned date surrogate key), sr_item_sk (item surrogate key), and sr_customer_sk (customer surrogate key). The join conditions of the WHERE clause specify that the ss_sold_date_sk is less than sr_returned_date_sk minus 365 days (i.e., the item sold must be returned within 365 days of the sold date), ss_item_sk is equal to sr_item_sk, and ss_customer_sk is equal to sr_customer_sk.

Assume that both tables are column-partitioned tables. In this query 200, the SELECT*clause references all columns from the two tables, while the join conditions in the WHERE clause only use three columns from each table, namely, ss_sold_date_sk, ss_item_sk and ss_customer_sk from the table store_sales_cp, and sr_returned_date_sk, sr_item_sk and sr_customer_sk from the table store_returns_cp.

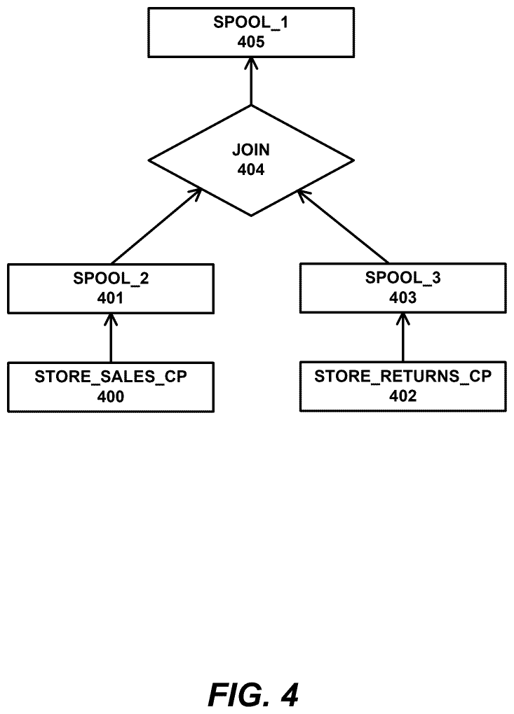

With early materialization, all columns are materialized into spool files when retrieving the tables before the join operation. The resulting query execution plan 208 is shown in FIG. 4 and performs the following steps or functions:
1. Retrieve table store_sales_cp (400), and materialize all columns from the table into spool_2 (401);
2. Retrieve table store_returns_cp (402), and materialize all columns from the table into spool_3 (403); and
3. Perform a join (404) of spool_2 (401) with spool_3 (403) using the join conditions, and store the results into spool_1 (405), wherein spool_1 (405) contains the end results of the query execution plan 208 and the query 200.

The Teradata® Vantage® RDBMS currently uses early materialization. In an early materialization query execution plan 208, some columns in the intermediate results (e.g., in spool 2 and spool 3) are not necessary (they are not needed by the join operation).

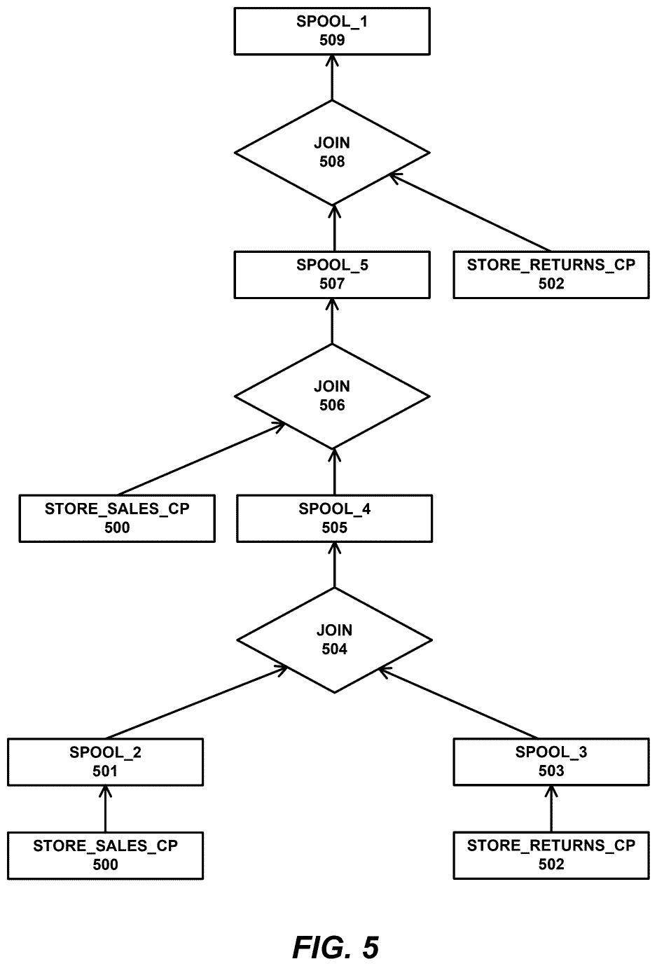

With late materialization, only the columns in the join conditions are materialized before the join operation; other columns are materialized only for the rows in the join results. The expected query execution plan 208 is shown in FIG. 5 and performs the following steps or functions:
1. Retrieve table store_sales_cp (500), and materialize the 3 columns of the join conditions into spool_2 (501);
2. Retrieve table store_returns_cp (502), and materialize the 3 columns of the join conditions into spool_3 (503);
3. Perform a join (504) of spool_2 (501) with spool_3 (503) through the 3 columns using the join conditions, and store the results into spool_4 (505), which also contains an identifier of each row, e.g., RowID, from both tables;
4. Perform a join (506) of spool_4 (505) with table store_sales_cp (500) through the RowID, materialize all columns from store_sales_cp (500), and store the results into spool_5 (507).
5. Perform a join (508) of spool_5 (507) with table store_returns_cp (502) through the RowID, materialize all columns from store_returns_cp (502), and store the results into spool_1 (509), wherein spool_1 (509) contains the end results of the query execution plan and the query.

Late materialization can reduce the size of the intermediate results (i.e., with fewer columns) and thus brings performance benefits in many cases; however, the inventor also noticed that late materialization requires accessing the base tables more than once, which involves extra cost.

In this example, late materialization has better performance when the join result is relatively small (i.e., the join operation filters out many rows), but it might be inefficient in the case that the join result is large (i.e., the join operation does not filter out many rows). Therefore, late materialization is expected to be a cost-based optimization.

Currently, the join-index-rewrite logic of the Teradata® Vantage® RDBMS provides a partial-covering-rewrite that produces a similar query execution plan 208 when join indexes are available (the join index must contain the columns used by the join).

Consider an example where there are two single-table join indexes, sji_ss and sji_sr, which are materialized views defined on tables store_sales_cp and store_returns_cp, respectively, as set forth below:

```
CREATE JOIN INDEX sji_ss AS
  SELECT RowID AS rid, ss_sold_date_sk, ss_item_sk,
  ss_customer_sk
  FROM store_sales_cp
  PARTITION BY COLUMN;
CREATE JOIN INDEX sji_sr AS
  SELECT RowID AS rid, sr_returned_date_sk, sr_item_sk,
  sr_customer_sk
  FROM store_returns_cp
  PARTITION BY COLUMN;
```

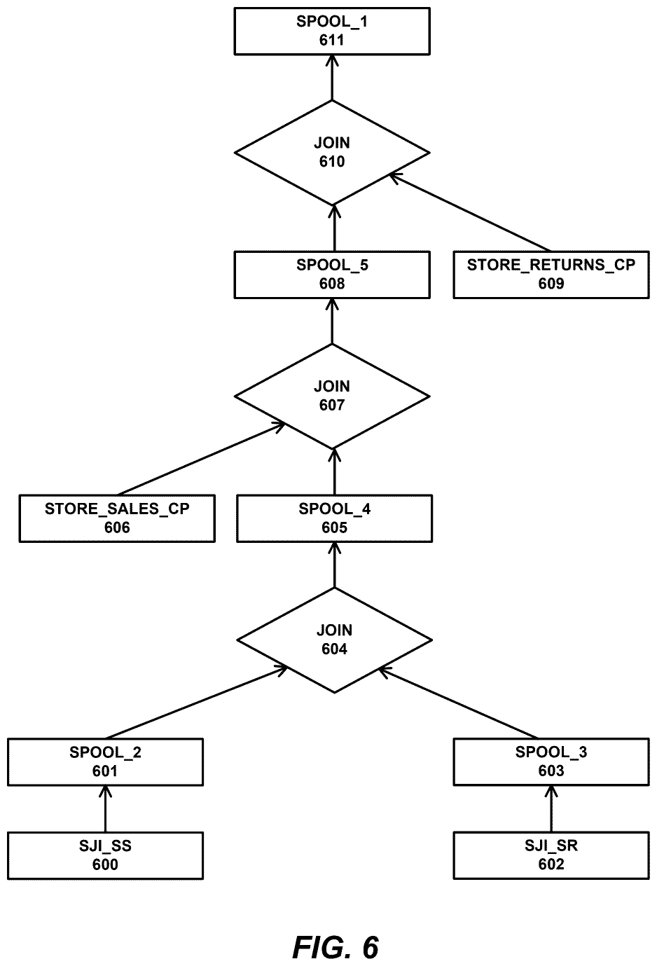

Note that each join index only contains columns in the join conditions of the query 200 and a RowID from the table. With these two join indexes, the following partial join-index-covering query execution plan 208 may be used (after comparing the estimated cost with a base query execution plan 208 without the join index), as shown in FIG. 6 and may perform the following steps or functions:
1. Retrieve join index sji_ss (600), and store into spool_2 (601);
2. Retrieve join index sji_sr (602), and store into spool_3 (603);
3. Perform a join (604) of spool_2 (601) with spool_3 (603), and store the results into spool_4 (605), which contains an identifier of each row, e.g., RowID, from both tables;
4. Perform a join (607) of spool_4 (605) with store_sales_cp (606) through the RowID, and store the results into spool_5 (608); and
5. Perform a join (610) of spool_5 (608) with store_returns_cp (609) through the RowID, and store the results into spool_1 (611), wherein spool_1 (611) contains the end results of the query execution plan and the query.

This query execution plan 208 looks similar to the late materialization query execution plan 208 of FIG. 5, and the join-index-rewrite is cost-based optimization.

However, there are disadvantages to this approach:
Creating, storing and maintaining the join indexes requires extra cost and storage space.
Queries 200 with different join columns need different join indexes. For example, join indexes sji_ss and sji_sr cannot be used for joins on columns not included in the join indexes.

### Virtual Join Index

A virtual join index is a non-sparse join index (i.e., there is no WHERE clause) defined on a single table with only the RowID in the SELECT list of the creation statement. Following is the creation statement in SQL for creating a virtual join index on table store_sales_cp:

```
CREATE JOIN INDEX vsji_ss AS
  SELECT RowID AS rid
  FROM store_sales_cp;
```

The virtual join index does not materialize the RowID of the base table. Instead, the RowID in the SELECT list is used only to guide the optimizer 308 for query rewrite to generate a join index partial-covering query execution plan 208 using this virtual join index in the same manner as it would for a regular join index under the same query rewrite framework.

By creating this virtual join index, late-materialization is enabled for the table [0060] store_sales_cp. That is, the virtual join index allows the optimizer 308 to produce and cost the late-materialization query execution plan 208 on the table (i.e., it does not require the optimizer 308 to select the late-materialization query execution plan 208, as the decision is cost-based).

Unlike a regular join index, the virtual join index does not materialize any columns of a [0061] base table, and thus does not need storage space for the columns from the base table or maintenance when the base table is updated.

During query 200 optimization, the virtual join index serves as a regular join index to trigger a partial-covering join-index-rewrite by the optimizer 308, but the rewrite process is enhanced to dynamically determine the columns that need to be materialized before the join (i.e., they are determined by the query 200, not by the virtual join index). Therefore, the virtual join index can be used for any query 200 with any join columns on the same base table. For example, the virtual join index vsji_ss on the base table store_sales_cp can produce a late-materialization query execution plan 208 for any query 200 with any join column on the table store_sales_cp.

Here, in addition to the virtual join index vsji_ss, assume a virtual join index vsji_sr is created on the table store_returns_cp:

```
CREATE JOIN INDEX vsji_sr AS
  SELECT RowID AS rid
  FROM store_returns_cp;
```

Given the same query 200 as set forth above:

```
SELECT *
  FROM store_sales_cp, store_returns_cp
  WHERE ss_sold_date_sk < sr_returned_date_sk-365
    AND ss_item_sk=sr_item_sk
    AND ss_customer_sk=sr_customer_sk;
```

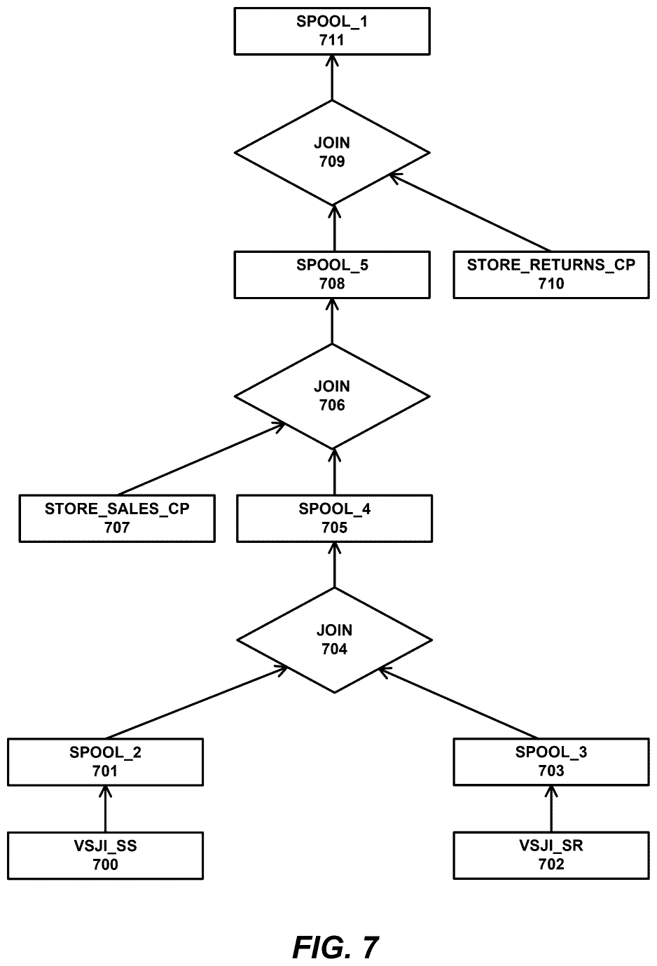

The query 200 is first rewritten as the following join index partial-covering query execution plan 208, as shown in FIG. 7, which performs the following steps or functions:
1. Retrieve virtual join index vsji_ss (700), materializing the 3 columns in the join conditions, and store the results into spool_2 (701);
2. Retrieve virtual join index vsji_sr (702), materializing the 3 columns in the join conditions, and store the results into spool_3 (703);
3. Perform a join (704) of spool_2 (701) with spool_3 (703), and store the results into spool_4 (705), which contains an identifier of each row, e.g., RowID, from both tables;
4. Perform a join (706) of spool_4 (705) with store_sales_cp (707) through the RowID, and store the results into spool_5 (708); and
5. Perform a join (709) of spool_5 (708) with store_returns_cp (710) through RowID, and store the results into spool_1 (711), wherein spool_1 (711) contains the end results of the query execution plan and the query.

Note that, in step 1, the 3 join columns of table store_sales_cp are materialized and in step 2, the 3 join columns of table store_returns_cp are materialized.

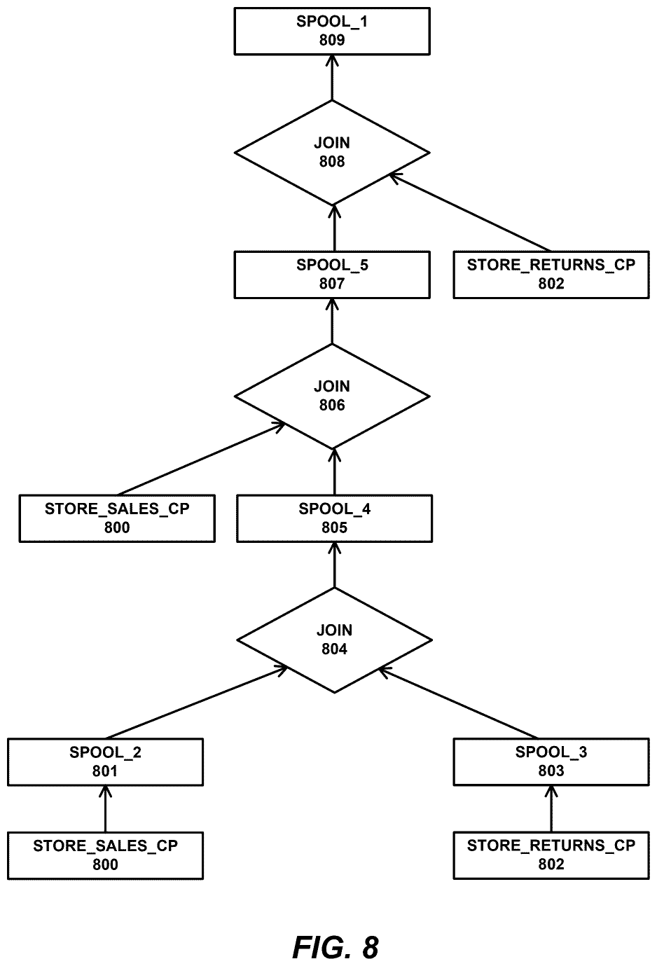

As the virtual join indexes do not contain any join columns, the optimizer 308 replaces the virtual join indexes with the base tables to produce the late-materialization query execution plan 208. This is shown in FIG. 8, which performs the following steps or functions:
1. Retrieve table store_sales_cp (800), materializing only the 3 columns in the join conditions, and store the results into spool_2 (801);
2. Retrieve table store_returns_cp (802), materializing only the 3 columns in the join conditions, and store the results into spool_3 (803);
3. Perform a join (804) of spool_2 (801) with spool_3 (803), and store the results into spool_4 (805), which contains an identifier for each row, e.g., RowID, from both tables;
4. Perform a join (806) of spool_4 (805) with store_sales_cp (800) through the RowID, materializing all columns for the qualified rows in the store_sales_cp (800), and store the results into spool_5 (807); and
5. Perform a join (808) of spool_5 (807) with store_returns_cp (802) through the RowID, materializing all columns for the qualified rows in the store_returns_cp (802), and store the results into spool_1 (809), wherein spool_1 contains the end results of the query execution plan and the query.

The optimizer 308 estimates the cost of this query execution plan 208, and also estimates the cost of the original early-materialization query execution plan 208, and then selects the query execution plan 208 with a lower cost for subsequent execution by the RDBMS 106.

### Experimental Results

The inventor prototyped the virtual join index approach of this invention, performed some experiments, and obtained the following experimental results.

For the query 200 described above, the tables store_sales_cp and store_returns_cp are both column partitioned tables defined the same as in the TPC-DS benchmark, which is a decision support (DS) benchmark query developed by Transaction Processing Performance Council (TPC) that models several generally applicable aspects of a decision support system (DSS), including queries and data maintenance. The TPC-DS benchmark query provides a representative evaluation of performance as a general purpose DSS.

The inventor tested the query 200 on both a base build (without the virtual join indexes defined) and a feature build (with the virtual join indexes defined), and found that the feature build selects the late-materialization query execution plan 208 and shows significant performance improvements over the early-materialization query execution plan 208 in the base build.

| Tests on 10GB TPC-DS dataset | Elapse Time |
|---|---|
| Base build: | 95 sec |
| Early-materialization query execution plan | |
| Feature build (with virtual join indexes): | 20 sec |
| Late-materialization query execution plan | |

The inventor also tested other TPC-DS queries 200, and obtained the following table of elapsed times for those queries 200, which shows an obvious performance improvement with the late-materialization query execution plans 208:

| | Elapsed Time on | Elapsed Time on | |
|---|---|---|---|
| | base build - Early- | feature build - Late- | Elapsed |
| | materialization | materialization | Time |
| Query | query execution plan | query execution plan | reduction |
| Q24_1 | 18 | 11 | 39% |
| Q34 | 30 | 18 | 40% |
| Q53 | 10 | 5 | 50% |
| Q63 | 9 | 4 | 55% |
| Q66 | 23 | 16 | 30% |
| Q73 | 30 | 23 | 23% |
| Q79 | 22 | 17 | 22% |

Note that, as late-materialization is cost-based, not all queries 200 used late-materialization; in this test, the inventor did not find any query 200 with an obvious performance regression.

### REFERENCES

The following publications are incorporated by reference herein:
[1] Daniel J. Abadi, Daniel S. Myers, David J. DeWitt, and Samuel Madden. Materialization Strategies in a Column-Oriented DBMS. In ICDE, 2007.
[2] DimitrisTsirogiannis, StavrosHarizopoulos, MehulA. Shah, JanetL. Wiener, and Goetz Graefe. 2009. Query Processing Techniques for Solid State Drives. In SIGMOD, 2009.
[3] G. A. Chernishev, V. Galaktionov, V. V. Grigorev, E. Klyuchikov, and K. Smirnov. A comprehensive study of late materialization strategies for a disk-based column-store. In Proceedings of the 24th International Workshop on Design, Optimization, Languages and Analytical Processing of Big Data (DOLAP) co-located with the 25th EDBT/ICDT, 2022.

### Flowchart

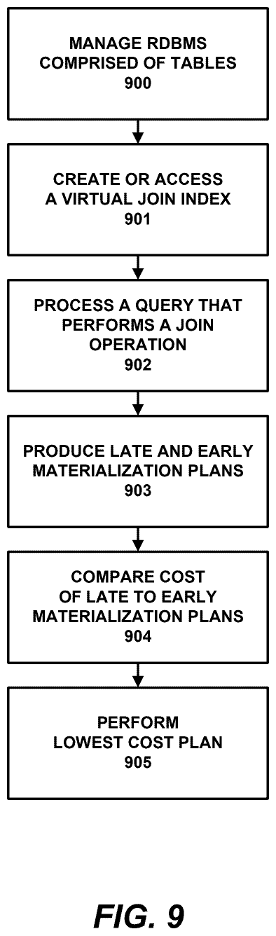

FIG. 9 is a flowchart that illustrates the steps performed in the present invention, when executing an RDBMS 106 in a computer system 100.

Block 900 represents the step of the RDBMS 106 managing a relational database comprised of at least a first table and a second table storing data. In one aspect, the first table and/or second table is column partitioned, wherein the columns are assembled into rows during materialization, before the rows are returned as query results.

Block 901 represents the step of the RDBMS 106 creating or accessing a virtual join index for processing columns of the first table or the second table. The virtual join index is a non-sparse join index containing only row identifiers for the first table or the second table in a creation statement for the virtual join index, wherein the virtual join index does not materialize any columns from the first table or the second table.

Block 902 represents the step of the RDBMS 106 processing a query that performs a join operation of the first table with the second table.

Block 903 represents the step of the RDBMS 106 using the virtual join index to produce and cost a late-materialization query execution plan for the query. The virtual join index is replaced with dynamically determined columns from the first table or the second table to produce and cost the late-materialization query execution plan for the query. The dynamically determined columns comprise the columns of the first table or the second table referenced by the join operation, wherein the dynamically determined columns are materialized before the RDBMS 106 performs the join operation in the query.

Block 904 represents the step of the RDBMS 106 comparing the cost of the late-materialization query execution plan for the query with a cost of an early-materialization query execution plan for the query, and selecting the late-materialization query execution plan or the early-materialization plan for execution by the RDBMS 106.

Block 905 represents the step of the RDBMS 106 performing the selected query execution plan.

### CONCLUSION

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method, comprising:
executing a relational database management system (RDBMS) in a computer system, wherein:
the RDBMS manages a relational database comprised of at least a first and a second table storing data;
the RDBMS creates or accesses a virtual join index for processing columns of the first table and the second table, wherein the virtual join index is s non-materialized index;
the RDBMS processes a query that performs a join operation of the first table with the second table; and
the RDBMS uses the virtual join index to produce and cost a late-materialization query execution plan for the query.

2. The method of claim 1, wherein the virtual join index is a non-sparse join index containing only row identifiers for the first table or the second table in a creation statement for the virtual join index.

3. The method of claim 2, wherein the virtual join index does not materialize any columns from the first table or the second table.

4. The method of claim 2, wherein the virtual join index is replaced, wherein the replacement comprises replacement of the virtual join index with the first table or the second table to produce and cost the late-materialization query execution plan.

5. The method of claim 4, wherein replacement of the virtual join index further comprises replacement of the virtual join index with dynamically determined columns from the first table or the second table to produce and cost the late-materialization query execution plan for the query.

6. The method of claim 5, wherein the dynamically determined columns comprise the columns of the first table or the second table referenced by the join operation in the query.

7. The method of claim 5, wherein the dynamically determined columns are materialized before the RDBMS performs the join operation in the query.

8. The method of claim 1, wherein the cost of the late-materialization query execution plan for the query is compared with a cost of an early-materialization query execution plan for the query, to select the late-materialization query execution plan or the early-materialization query execution plan for execution by the RDBMS.

9. The method of claim 1, wherein at least one of the first table and second table is column partitioned, and the columns of the column-partitioned at least one of the first table and second table are assembled into rows during materialization, before the rows are returned as results for the query.

10. An apparatus, comprising:
a computer executing a relational database management system (RDBMS), wherein: the RDBMS manages a relational database comprised of at least a first and a second table storing data;
the RDBMS creates or accesses a virtual join index for processing columns of the first table and the second table, wherein the virtual join index is a non-materialized index;
the RDBMS processes a query that performs a join operation of the first table with the second table; and
the RDBMS uses the virtual join index to produce and cost a late-materialization query execution plan for the query.

11. The apparatus of claim 10, wherein the virtual join index is a non-sparse join index containing only row identifiers for the first table or the second table in a creation statement for the virtual join index.

12. The apparatus of claim 11, wherein the virtual join index does not materialize any columns from the first table or the second table.

13. The apparatus of claim 11, wherein the virtual join index is replaced, wherein the replacement comprises replacement of the virtual join index with the first table or the second table to produce and cost the late-materialization query execution plan.

14. The apparatus of claim 13, wherein replacement of the virtual join index further comprises replacement of the virtual join index with dynamically determined columns from the first table or the second table to produce and cost the late-materialization query execution plan for the query.

15. The apparatus of claim 14, wherein the dynamically determined columns comprise the columns of the first table or the second table referenced by the join operation in the query.

16. The apparatus of claim 14, wherein the dynamically determined columns are materialized before the RDBMS performs the join operation in the query.

17. The apparatus of claim 10, wherein the cost of the late-materialization query execution plan for the query is compared with a cost of an early-materialization query execution plan for the query, to select the late-materialization query execution plan or the early-materialization query execution plan for execution by the RDBMS.

18. The apparatus of claim 10, wherein at least one of the first table and second table is column partitioned, and the columns of the column-partitioned at least one of the first table and second table are assembled into rows during materialization, before the rows are returned as results for the query.

19. A computer program product, the computer program product comprising a non-transitory computer readable storage medium having program instructions tangibly embodied therein, the program instructions executable by a computer system to cause the computer system to perform a method, the method comprising:
executing a relational database management system (RDBMS) in a computer system, wherein: the RDBMS manages a relational database comprised of at least a first and a second table storing data;
the RDBMS creates or accesses a virtual join index for processing columns of the first table and the second table, wherein the virtual join index is a non-materialized index;
the RDBMS processes a query that performs a join operation of the first table with the second table; and
the RDBMS uses the virtual join index to produce and cost a late-materialization query execution plan for the query.

20. The computer program product of claim 19, wherein the virtual join index is a non-sparse join index containing only row identifiers for the first table or the second table in a creation statement for the virtual join index.
